(19) United States
(12) Patent Application Publication
(10) Pub. No.: US 2021/0078216 A1
(43) Pub. Date: Mar. 18, 2021

(54) STRUCTURED ROLLERS IN THE CALENDERING AND POST-CALENDERING PROCESS

(71) Applicant: TESA SE, Norderstedt (DE)

(72) Inventors: Bernd DIETZ, Ammersbek (DE); Karsten KUSS, Hamburg (DE)

(73) Assignee: TESA SE, Norderstedt (DE)

(21) Appl. No.: 16/967,231

(22) PCT Filed: Feb. 4, 2019
(86) PCT No.: PCT/EP2019/052675

§ 371 Date: Aug. 4, 2020

(30) Foreign Application Priority Data
Feb. 5, 2018 (DE) 10 2018 201 684.4

(51) Int. Cl. B29C 43/46; B32B 5/02; B29C 43/24; B29C 43/28

(52) U.S. Cl. CPC B29C 43/46; B32B 5/024; B29C 43/24; B29K 2105/0097; B32B 2405/00; B29C 2043/462; B29C 43/28

(57) ABSTRACT

Calendering devices and processes are provided that process a fluid that has been rendered adhesive or is inherently adhesive, wherein processing typically involves forming of the fluid into a film of defined layer thickness and applying the fluid to a carrier material, post-calendering, or a combination of at least two of the above-mentioned processes. The devices may comprise a feed device for feeding the fluid, a multi-roller mechanism having at least two calendering rollers, and at least one calendering nip for processing the fluid, in which at least one of the at least two calendering rollers has an average roughness depth Rz of between 5 μm and 15 μm or between 9 μm and 13 μm.

### CROSS-REFERENCE TO RELATED APPLICATIONS

This application is a 371 of PCT/EP2019/052675, filed Feb. 4, 2019, which claims foreign priority benefit under 35 U.S.C. § 119 of the German Patent Application No. DE 10 2018 201 684.4 filed Feb. 5, 2018, the disclosures of which are incorporated herein by reference in their entireties.

The present invention relates to a calendering device configured and equipped for the processing of a fluid that has acquired adhesive properties or inherently has adhesive properties, where the processing typically comprises the shaping of the fluid to give a film of defined layer thickness, the application of the fluid to a carrier material, and post-calendering, or a combination of at least two of the abovementioned procedures, comprising feed equipment for the introduction of the fluid and a multiroll unit with at least two calendering rolls and at least one calendering nip for the processing of the fluid. The invention further relates to a calendering process for the processing of a fluid that has acquired adhesive properties or inherently has adhesive properties, where the processing comprises the shaping of the fluid to give a film of defined layer thickness, the application of the fluid to a carrier material, and post-calendering, or a combination of at least two of the abovementioned procedures, and also to an adhesive tape with an adhesive composition obtained by this process.

### BACKGROUND

Application by roll comprises a large number of technologies used for shaping and wind-up of polymers by means of two or more rolls, or else for application of polymers to a carrier: by way of example, coating calenders in the rubber industry serve for the shaping and coating of polymers onto materials in web form, e.g. onto woven fabric or nonwovens. In such cases, the rolls are generally designed to be heatable, in order to introduce heat into the polymer. The polymer thus typically becomes less viscous and more moldable. This permits simpler design of the rolls and reduces capital expenditure and operating costs.

In the case of high-viscosity polymers it is preferable to use multiroll calenders to permit achievement of low application weights. In such cases, starting from a relatively large gap between the applicator rolls, application weight is reduced in stages via increasing differential velocities (friction) of the subsequent rolls until the target weight is achieved.

Difficulties can arise if the polymers have adhesive properties at processing temperature and tend to adhere on the rolls. Examples here are certain rubber mixtures or PVC mixtures, and also in particular adhesives. The adhesive properties that cause problems here can, within certain limits, be eliminated by specific setting of the temperatures and friction values and optionally of other processing parameters.

However, this procedure is subject to limitations in the case of systems with a high level of adhesive properties, e.g. acrylate systems or resin-blended rubber formulations, or EVA- or synthetic-rubber-based adhesives.

For the processing of formulations with a high level of adhesive properties it is therefore preferable to use rolls that have undergone antiadhesive modification. Relevant examples are mentioned by way of example in lines 16-41 on page 13 of EP 2 192 148 B1. However, these rolls generally have the disadvantage of limited operating times because, over the course of time, their antiadhesive effect decreases and the antiadhesive components are subject to removal by wear or by leaching. The selection of a variant that functions in a stable manner in the production procedure is moreover a very complex matter, because coating rolls thus modified are firstly intended to achieve good and complete take-up of the preformed film from the preceding roll and must then in turn achieve complete transfer of said film onto the subsequent roll without retention of any residue. Processing latitude is therefore subject to narrow limits and is restricted to a specific formulation and a specific procedure.

Alternative systems, for example fluorine-modified coatings, have considerably longer operating times, but have inadequate antiadhesive effect in relation to systems with a high level of adhesive properties. Although in such cases sufficiently good take-up of the polymer to be calendered can be achieved from the relevant roll surface it is, in contrast, not possible to achieve complete transfer of same onto the subsequent roll.

For systems with a high level of adhesive properties it is also impossible to consider the use of typical metal screen rolls suitable for acrylate coating, with about 140 cells/cm and about 10 μm cell wall width (cf. lines 43-46 on page 13 of EP 2 192 148 B1), because these rolls cannot achieve complete take-up of the adhesive compositions. Residues remain on the preceding roll; the resultant procedure is unstable, and not viable for production purposes.

Because of this, the roll-applicator unit is completely unable to coat many formulation variants, or cannot coat them with the desired web speeds and/or application weights.

Another problem that arises relates to the anchoring strength of the polymer on the carrier material. For economic reasons it is desirable here to avoid use of adhesion promoters on the webs to be coated. Corona pretreatment, plasma pretreatment or flame pretreatment is cost-efficient but in the case of nonwovens and woven fabrics often fails to give the desired result.

Treatment of the material coated with polymer with adhesive properties, either carried out during the procedure (“inline”) or carried out in a further operation (“offline”), by means of pressure and/or heat (“post-calendering”), in a nip in order to improve adhesion of the adhesive on the carrier material, is subject to severe limitation. When advantageous processing temperatures are used in particular for pressure-sensitive adhesive compositions, but also for other polymers such as polyethylenes or ethylene-vinyl acetates, these materials exhibit adhesive properties that lead to severe adhesion on the roll surfaces contacted, and finally to an unstable procedure. Here again, use of antiadhesive roll surfaces is subject to limitation due to the difficulties already described above relating to selection of material and to operating time. Because of limited hardness values, polymeric rolls with antiadhesive surfaces cannot transfer the necessary forces within the nip.

For these reasons, the above known types of rolls cannot be considered for use for an efficient, flexible roll-application process for coating purposes, or in post-calendering for improved anchoring of polymers having a high level of adhesive properties.

### SUMMARY OF THE DISCLOSURE

It is therefore an object of the invention to enable processability of polymers with a high level of adhesive properties, and also sufficient bond strengths thereof on nonwovens and woven fabrics in the roll process.

This relates firstly in particular to the shaping of the polymers to give a film of defined layer thickness via preforming in the nip and to the transfer to one or more subsequent rolls with graded speeds of rotation. The abovementioned known controllable variables for improving processability are often insufficient here.

Another factor considered is the transfer of the shaped melt film from the final calender roll onto the carrier material in web form. The known processes cannot achieve adequate bond strength here, in particular in the case of open or structured carrier materials, e.g. woven-fabric and nonwoven materials with small pore sizes, because the procedure permits only application of a limited linear pressure. If this is too small, and the viscosity of the polymer melt is too high, and the hydraulic diameter of the pores is also too small, the melt cannot then achieve sufficient penetration into the apertures of the carrier.

### BRIEF DESCRIPTION OF THE DRAWINGS

FIG. 1 shows a structure of a calender unit, according to one or more examples of the disclosure.

FIG. 2 shows a structure of a calender and post-calendering unit, according to one or more examples of the disclosure.

FIG. 3 is a graph shows peel forces of rolls used as a function of temperature and of roll surface, according to one or more examples of the disclosure.

### DETAILED DESCRIPTION OF THE DISCLOSURE

This object is achieved in the invention in a calendering device of the type mentioned in the introduction in that the average roughness depth Rz of at least one of the at least two calendering rolls is between 5 μm and 15 μm, in particular between 9 μm and 13 μm.

The average roughness depth Rz is defined here as

Rz=1/n·(Rz₁+Rz₂+Rz₃+ . . . Rzₙ),

i.e. is defined as the average value of the individual roughness depths, measured at various points, of the respective roll, where n is the number of values measured. The measurement is made in accordance with the requirements of DIN EN ISO 3274.

By virtue of this suitable selection of the roll surfaces and modification thereof as required by the processing conditions, it is possible to avoid use of roll materials that have little loadbearing capability and have relatively low operating time or inadequate strength, and cannot meet the stringent durability and robustness requirements of everyday production operations and moreover also have high purchase costs. In an alternative, adequate processing latitude for stable, robust processing of materials having adhesive properties is established via suitable selection of roll roughness of roll materials that are readily available and are widely used.

The specific selection of rolls with suitable roughness values permits processing in the roll-application process even in the case of synthetic and other rubbers having a high level of adhesive properties, and also mixtures thereof. However, it also permits processing and post-calendering of PU polymers, EVA polymers and other polymers and polymer mixtures that have acquired adhesive properties or inherently have adhesive properties.

The average roughness depth Rz of all calendering rolls, and specifically independently of one another, is preferably between 5 μm and 15 μm, in particular between 9 μm and 13 μm; i.e. all calendering rolls are preferably configured according to the invention.

It is moreover preferable that at least two of the at least two calendering rolls in the calendering device are post-calendering rolls.

Steel is typically used as material for the base of the roll. Metallic surfaces are particularly suitable as surface of the calendering rolls, and therefore at least one of the at least two calendering rolls in the calendering device of the invention has a metallic surface. Steel or chromium can in particular be used as metallic surfaces. Rolls made of hard material, in particular those with a surface made of metal carbide, are particularly suitable here, as also are rolls with a chromium surface.

In the roll procedures of the invention, these metallic surfaces provide the typical high strength values and long operating times in the procedure. Rolls therefore preferably used according to the invention are steel rolls, chromed steel rolls, and also rolls made of hard material using metal carbides that provide strength. Mention may be made in particular here of tungsten carbide surfaces.

Particularly successful conduct of a calendering procedure can be achieved if at least one of the at least two calendering rolls is configured to be heatable. A variable roll temperature provides a further parameter which can be used to influence the calendering procedure and therefore the resultant product. The roll temperatures of the calendering rolls configured to be heatable are preferably selected here independently of one another in the range of 50 to 150° C., in particular in the range of 80 to 120° C.

The calendering device moreover preferably comprises at least one polymer counter-roll. This provides a further nip, and moreover in particular for the guidance of a carrier material onto which the polymer is applied.

The calendering device of the invention can be used to process any desired fluid polymers.

The calendering device is in particular suitable for fluids selected from the group comprising compositions that have adhesive properties or have acquired adhesive properties, in particular pressure-sensitive adhesive compositions based on rubbers, on synthetic rubbers, on polyurethanes, on epoxies, on ethylene-vinyl acetates and on poly(meth)acrylates and mixtures of these. The device of the invention is specifically suitable for polymers which have a particularly high level of adhesive properties, where these cannot be satisfactorily processed by conventional calendering devices.

As far as the viscosities of processable polymers are concerned, the polymers that can particularly advantageously be processed by the device of the invention lie within a viscosity range of 500 to 150 000 Pa*s at the respective coating temperature and 1 rad/s.

The object of the present invention is moreover achieved via a calendering process for the processing of a fluid that has acquired adhesive properties or inherently has adhesive properties, where the processing comprises the shaping of the fluid to give a film of defined layer thickness, the application of the fluid to a carrier material, and post-calendering, or a combination of at least two of the abovementioned procedures, in that the process is carried out on a device described above. The preferred embodiments of the calendering device are also applicable to the calendering process and vice versa.

The polymer processed by the process of the invention, in particular polyacrylate, can be used as pressure-sensitive adhesive composition with excellent results, preferably as pressure-sensitive adhesive composition for an adhesive tape, where the pressure-sensitive adhesive composition is present as film on one or both sides of a carrier film. Examples of uses, without any claim to completeness, are technical adhesive tapes, in particular for use in the construction industry, e.g. insulation tapes, corrosion-protection tapes, adhesive aluminum tapes, woven-fabric-reinforced-film adhesive tapes (duct tapes), adhesive tapes for specialized construction purposes, e.g. vapor barriers, adhesive assembly tapes, cable-wrapping tapes, self-adhesive films and/or paper labels, and also uses for the automobile industry for fixing of parts or covering of cables.

The polymer processed by the process of the invention, in particular rubber or synthetic rubber, can moreover be used with excellent results as pressure-sensitive adhesive composition, preferably as pressure-sensitive adhesive composition for an adhesive tape, where the pressure-sensitive adhesive composition is present as film on one or both sides of a carrier film. Examples of uses, without any claim to completeness, are technical adhesive tapes, in particular for use in the construction industry, e.g. woven-fabric tapes, woven-fabric-reinforced-film adhesive tapes (duct tapes), vapor barriers, and also adhesive assembly tapes, cable-wrapping tapes, and also uses for fixing of parts or covering of cables.

However, the calendering device of the invention and the calendering process of the invention do not only improve the processability of the polymer composition by in particular preventing adhesion of any polymer constituents on the rolls: the properties of the resultant products can also be improved. By way of example in the case of adhesive tapes in particular, anchoring strength of the polymer on the carrier material is improved when the calendering device of the invention is used. The present invention therefore moreover provides an adhesive tape comprising a pressure-sensitive adhesive composition produced by the calendering process described above. These adhesive tapes can be either single- or double-sided. Such adhesive tapes comprise at least one carrier material. Carrier material preferably used here is woven fabric, in particular woven cotton fabric, knitted fabric, nonwoven or paper, in their various embodiments.

This type of adhesive tape preferably has a weight per unit area between 55 and 120 g/m². The weight per unit area here is based on the applied mass of the adhesive layer, and not on the entire adhesive tape with carrier. When open or structured carrier materials and/or the polymers described having a particularly high level of adhesive properties were used with the known processes and devices in the calendering procedure, it was impossible to achieve the above weight per unit area values over long periods in a stable procedure.

Adhesive tapes of the invention having at least one carrier feature high bond strength of pressure-sensitive adhesive composition and carrier material. Bond strength, also termed anchoring strength, describes the force required to separate the adhesive composition from the carrier material. Bond strength should always be higher than the cohesion of the adhesive composition and the adhesion of adhesive composition to the substrate: this ensures that the adhesive tape can be peeled from the substrate without resultant destruction of the adhesive tape or retention of problematic residues on the substrate. Bond strength obtainable with the device of the invention and the process of the invention is preferably at least 17 N/cm.

### Working Examples

Test Methods

Test Method I—Roughness Depth Rz

The roughness depth of the rolls used is measured by using a profilometer. The test equipment was a Mahr MarSurf PS1 from Mahr GmbH, Gottingen. The measurement method was as specified in DIN EN ISO 3274.

Test Method II—Peel Force

Adhesive properties of the rolls used in relation to polymers having adhesive properties were characterized by determining peel forces in relation to a defined adhesive tape at processing temperatures. In cases where it was not possible to carry out a measurement under the processing conditions, measurements were made at the closest-possible temperatures.

For this, 3 passes of an applicator roll (2 kg) at a velocity of 5 m/min in machine-running direction were used to roll, and fix, a 19 mm test strip of the adhesive tape to the temperature-controlled roll sample. Immediately thereafter, a spring balance was used to measure the peel force in g at defined velocity (0.35 m/min) at a peel angle of 90°. Measured value and fracture pattern are recorded.

Test Method III—Viscosity

Viscosity is measured with an ARES (Rheometric Scientific) rheometer with a cone-and-plate system with diameter 50 mm at 115° C. and shear rate 1 s⁻¹.

Test Method IV—Anchoring Strength

Anchoring strength is determined by using a double-sided adhesive tape to fix a sample of width 10 mm of the coating product on a steel plate. A total of 10 passes with a steel roller with a weight of 2 kg at a velocity of 10 m/min were then used to roll, and fix, tesa test tape 7476 to the open adhesive side of the sample. The anchoring strength of the test tape on the composite is determined by using a Zwick tensile tester at a peel angle of 180° at 23° C./55% rh and peel velocity 500 mm/min. Anchoring strength is determined in N/cm.

### EXAMPLES

Raw Materials Used

TABLE 1
Raw materials used

| | Name | Type | Producer |
|---|---|---|---|
| Elastomer | V145 | Natural rubber | |
| | Europrene | Synthetic rubber, linear | Versalis |
| | Sol T 190 | block copolymer obtained | S.p.A. |
| | | by anionic polymerization | |
| | | based on styrene and | |
| | | isoprene; styrene content | |
| | | 16% by weight, diblock | |
| | | proportion 25% by weight. | |
| Adhesive | Regalite | Hydrocarbon resin | Eastman |
| resin | R1125 | (MMAP 83° C.; | Chemical |
| | | DACP 55° C., | |
| | | TRB 123° C.) | |
| Filler | MS40 | | |
| | chalk | | |
| Antioxidant | Irganox | 2,4-Bis(dodecylthiomethyl)- | BASF SE |
| | 1726 | 6-methylphenol | |

### Example 1: Rolls with Rz about 1 μm

A rubber-based adhesive composition with the following components:

| | |
|---|---|
| 15% by weight | of V145 natural rubber |
| 15% by weight | of Europrene Sol T 190 synthetic rubber |
| 38% by weight | of Regalite R 1125 hydrocarbon resin |
| 31% by weight | of MS40 chalk |
| 1% by weight | of Irganox 1726 antioxidant |

was calendered in the roll-application process.

Viscosity determined was 17 000 Pa*s at 115° C. and 1 rad/s shear gradient.

The adhesive composition had been produced in advance in a 25 l kneader from AMK and drawn off into siliconized cartons measuring 50*50*1000 mm. This adhesive composition in strand form is fed into a melting extruder from Troester (GS60*10 D) and, at a temperature of 120° C. at 45 kg/h throughput, fed into the feed nip of a 3-roll L-calender.

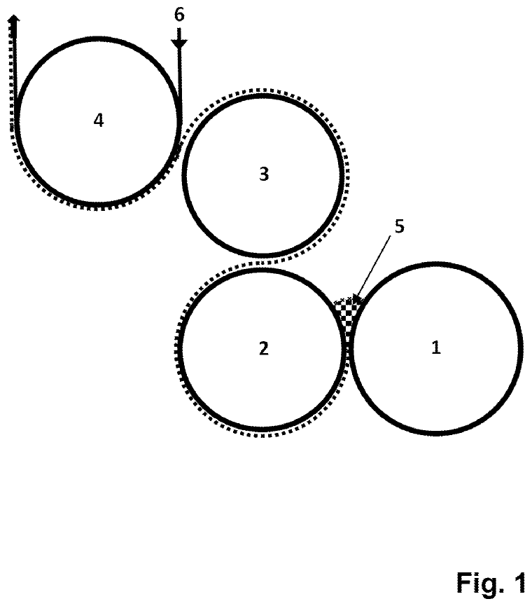

FIG. 1 shows the structure of the calender used in Examples 1 to 4.

The 1^{st} roll 1, known as the feed roll, is equipped with a polished chromium surface; the 2^{nd} roll 2, the transfer roll, and also the 3^{rd} roll 3, the receiving roll, have chromium surfaces with average roughness depths Rz of about 1 μm. The carrier web 6 made of 120-mesh woven spun-cellulose fiber runs on an 80° Sh A polymer counter-roll 4 into the nip, and is intended to achieve complete take-off of the adhesive 5 from the receiving roll. Web velocity is adjusted to 15 m/min; application weight on the woven fabric is 100 g/m².

The feed roll 1 is stationary during operation, whereas the transfer roll 2 is operated at 20% of web velocity, and the receiving roll 3 is operated concurrently with the web.

At temperatures of W1=120° C., W2=120° C., W3=110° C., counter-roll=80° C., full-surface shaping of adhesive is achieved on roll 2, but residue-free adhesive transfer is not achieved from roll 2 to 3 or in the coating nip from roll 3 to the carrier web 6. The roll surfaces of rolls 2 and 3 are unsuitable.

### Example 2: Rolls with Rz 23 μm

The experimental setup and process parameters selected were the same as in Example 1. Only roll 3 was replaced by a variant with a rougher surface with average roughness depth Rz 23 μm.

Full-surface shaping of adhesive is achieved on roll 2, but considerable residues remain during transfer of adhesive composition from roll 2 to 3, and it is therefore impossible to produce a coherent coating film on the woven fabric. The roll surfaces of roll 2 in combination with roll 3 are unsuitable.

### Example 3: Rolls with Rz about 10 μm

The experimental setup and process parameters selected were the same as in Example 1. Only rolls 2 and 3 were replaced by variants with moderate roughness (Rz about 10 μm).

Surprisingly, this roll arrangement achieved full-surface shaping of adhesive on roll 2 and residue-free adhesive transfer from roll 2 to 3, and also in the coating nip from roll 3 to the carrier web 6.

### Example 4: Bond Strength for 150-Mesh Woven Fabric

Starting from Example 3, rolls 2, 3 with average roughness depth about 10 μm were again used in the calender. A 150-mesh woven cotton fabric was used as carrier material 6; in respect of other factors, the experimental setup and process parameters selected were the same as in Example 1.

Coating of the carrier material is achieved, with a coherent, uniform adhesive layer with application weight 100 g/m². Bond strength values determined immediately after production are 12.6, 12.1 and 12.7 N/cm. The desired bond strength is 17 N/cm.

### Example 5: Bond Strength for 150-Mesh Woven Fabric and Roll 8 with Rz=9 μm

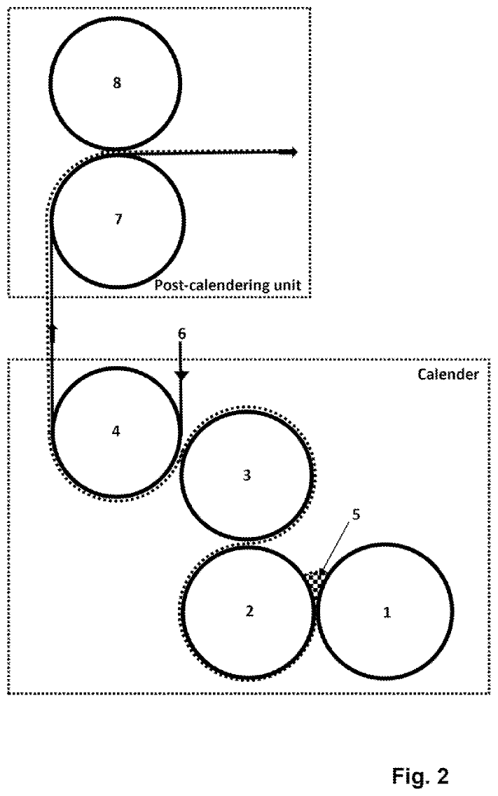

FIG. 2 shows the structure of the calender and of the post-calendering unit used in Examples 5 to 7:

The structure of the calender corresponds to that shown in FIG. 1. The device shown in FIG. 2 additionally comprises a post-calendering unit.

Starting from Example 4, rolls 2, 3 with average roughness depth Rz about 10 μm were again used in the calender. A 150-mesh woven cotton fabric was again used as carrier material 6, and the experimental setup and process parameters selected were the same as in Example 4. Immediately after the composite leaves the calender unit, it is additionally passed into a temperature-controlled 2-roll nip (“post-calendering unit”). This is positioned with a rubber roll 7 of 90° Sh A hardness facing toward the reverse side of the carrier web 6 and with the adhesive side of the carrier web 6 facing toward a steel roll 8 with Rz value 9 μm. The temperatures are 80 and, respectively, 120° C. (rolls 7 and 8); linear pressure is 50 N/cm.

Coating of the carrier material is achieved, with a coherent, uniform adhesive layer with application weight 100 g/m². The material does not stick on the steel roll. Bond strength values determined immediately after production are 17.2, 18.0 and 17.9 N/cm. The desired bond strength is 17 N/cm.

### Example 6: Bond Strength for 150-Mesh Woven Fabric and Roll 8 with Rz=0.2 μm

Starting from Example 5, rolls 2, 3 with average roughness depth Rz about 10 μm were again used in the calender. A 150-mesh woven cotton fabric was again used as carrier material; in respect of other factors, the experimental setup and process parameters selected were the same as in Example 4.

Again, immediately after the composite leaves the calender unit, it is passed into a post-calendering unit. This is positioned with a rubber roll 7 of 90° Sh A hardness facing toward the reverse side of the carrier web 6 and with the adhesive side of the carrier web 6 facing toward a steel roll 8 with Rz value 0.2 μm. The temperatures are 80 and, respectively, 120° C. (rolls 7 and 8); linear pressure is 50 N/cm.

Coating of the carrier material is achieved, with a coherent, uniform adhesive layer with application weight 100 g/m². However, the material sticks on the steel roll 8; no evaluation of bond strength is possible.

### Example 7: Bond Strength for 150-Mesh Woven Fabric and Roll 8 with Rz=23 μm

Starting from Example 5, rolls 2, 3 with average roughness depth Rz about 10 μm were again used in the calender. A 150-mesh woven cotton fabric was again used as carrier material; in respect of other factors, the experimental setup and process parameters selected were the same as in Example 4.

Again, immediately after the composite leaves the calender unit, it is into a post-calendering unit. This is positioned with a rubber roll 7 of 90° Sh A hardness facing toward the reverse side of the carrier web 6 and with the adhesive side of the carrier web 6 facing toward a steel roll 8 with Rz value 23 μm. The temperatures are 80 and, respectively, 120° C. (rolls 7 and 8); linear pressure is 50 N/cm.

Coating of the carrier material is achieved, with a coherent, uniform adhesive layer with application weight 100 g/m². The material does not stick on the steel roll 8.

Bond strength values determined immediately after production are 15.1, 14.6 and 14.7 N/cm. The desired bond strength is 17 N/cm.

The experiments prove that adhesive-contacting metal rolls with surface roughnesses having average roughness depths of 1<Rz<23 μm are suitable for achieving adequate bond strength after calender coating.

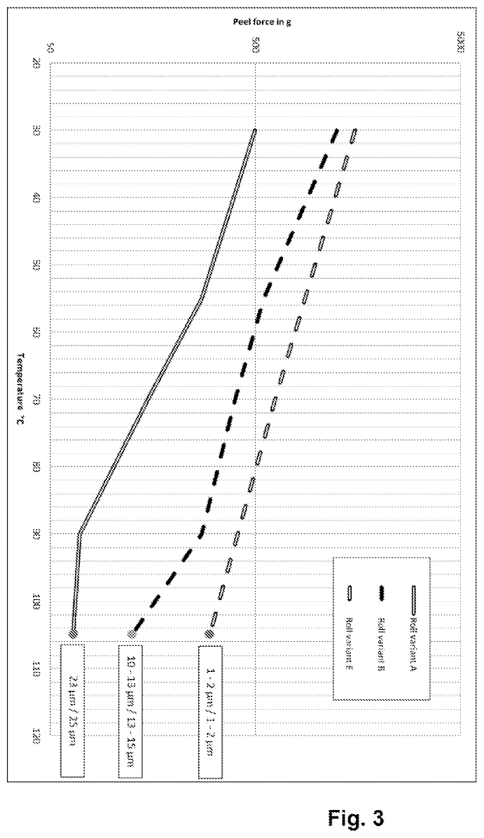

FIG. 3 shows the peel forces of the rolls used as a function of temperature and of roll surface. As can be seen from FIG. 3, the peel forces decrease with increasing roughness, and also with increasing temperature.

The examples show that particularly smooth rolls with correspondingly small roughness values (e.g. Rz about 1 μm) are not suitable in the calendering procedure for achieving complete take-up, and transfer to the subsequent roll, of melts having adhesive properties, e.g. PSA or other polymers. Complete transfer is not achieved even to easily wettable carrier materials such a papers, nonwovens or woven fabrics, and therefore rolls with these roughness depths are not suitable for the production process.

Rough rolls with Rz values of 15 μm and above are also unsuitable in the calendering procedure for ensuring complete take-up and transfer of the polymers having adhesive properties. In many cases here, the point of weakness preventing use in the production process relates simply to complete take-up of the polymer to be processed.

Surprisingly, surfaces with Rz values of 5-15 μm have proven to be particularly suitable. They have good properties in respect of complete take-up and transfer of the processed polymers.

It is thus possible to calender viscosities in the range of 500 to 150 000 Pa*s in a stable manner in a reliable procedure at processing temperature and 1 rad/s shear gradient.

1. A calendering device configured for processing of a fluid that has acquired adhesive properties or inherently has adhesive properties, where the processing comprises shaping of the fluid to form a film of defined layer thickness, applying the fluid to a carrier material, post-calendering, or a combination of at least two of the above-mentioned processing procedures, the calendaring device comprises:
a feed equipment configured for the introduction of the fluid;
a multiroll unit having least two calendering rolls; and
at least one calendering nip configured for the processing of the fluid,
wherein an average roughness depth Rz of at least one of the at least two calendering rolls of the multiroll is between 5 μm and 15 μm.

2. The calendering device of claim 1, wherein the average roughness depth Rz of all calendering rolls, and specifically independently of one another, is between 5 μm and 15 μm.

3. The calendering device of claim 1, wherein at least two of the at least two calendering rolls are post-calendering rolls.

4. The calendering device of claim 1, wherein at least one of the at least two calendering rolls has a metallic surface.

5. The calendering device of claim 1, wherein at least one of the at least two calendering rolls is configured to be heatable.

6. The calendering device of claim 5, wherein roll temperatures of the calendering rolls configured to be heatable is selected independently of one another at least in the range of 50 to 150° C.

7. The calendering device of claim 1, further comprising at least one polymer counter-roll.

8. The calendering device of claim 1, wherein the fluid is selected from the group comprising compositions that have adhesive properties or have acquired adhesive properties.

9. A calendering process for the processing of a fluid that has acquired adhesive properties or inherently has adhesive properties, the calendaring process comprises:
shaping of the fluid to give a film of defined layer thickness;
applying the fluid to a carrier material;
post-calendering; and
a combination thereof,
wherein the calendaring process is carried out on the device of claim 1.

10. An adhesive tape comprising a pressure-sensitive adhesive composition, wherein the pressure-sensitive adhesive composition has been produced by the calendering process of claim 9.

11. The adhesive tape of claim 10, wherein the weight per unit area of the adhesive tape is between 55 and 120 g/m².

12. The adhesive tape of claim 10, further comprising at least one carrier material.

13. The adhesive tape of claim 12, wherein the at least one carrier material is selected from the group consisting of woven fabric.

14. The adhesive tape of claim 13, wherein a bond strength of the pressure-sensitive adhesive composition and at least one carrier material is at least 17 N/cm.

15. The calendering device of claim 2, wherein the average roughness depth Rz of the at least one of the at least two calendering rolls of the multiroll is between 9 μm and 13 μm.

16. The calendering device of claim 3, wherein the average roughness depth Rz of all calendering rolls, and specifically independently of one another, is between 9 μm and 13 μm.

17. The calendaring device of claim 4, wherein the at least one of the at least two calendering rolls has a metal carbide surface.

18. The calendaring device of claim 6, wherein the roll temperatures of the calendering rolls configured to be heatable is selected independently of one another at least in the range of 80 to 120° C.

19. The calendaring device of claim 8, wherein the group compositions having adhesive properties or having acquired adhesive properties comprises pressure-sensitive adhesive compositions.

20. The calendaring device of claim 19, wherein the pressure-sensitive adhesive compositions are based on rubbers, synthetic rubbers, polyurethanes, epoxies, ethylene-vinyl acetates, poly(meth)acrylates, and at least one mixture thereof.
